(19) United States
(12) Patent Application Publication
(10) Pub. No.: US 2005/0255347 A1
(43) Pub. Date: Nov. 17, 2005

(54) Electrode paste for manufacturing a catalyst layer for an electrochemical cell and method for manufacturing a catalyst layer

(75) Inventors: Christiane Jacksch, Laatzen (DE); Wolfgang Zipprich, Isenbuttel (DE); Gerold Hubner, Braunschweig (DE)

Correspondence Address: LERNER AND GREENBERG, PA, P O BOX 2480, HOLLYWOOD, FL, 33022-2480, US

(73) Assignee: Volkswagen Aktiengesellschaft

(21) Appl. No.: 11/123,458

(22) Filed: May 5, 2005

(30) Foreign Application Priority Data
May 13, 2004 (DE) 10 2004 024 844.3

(51) Int. Cl. H01M 8/00; B05D 5/12; B01J 31/00; B01J 21/18

(52) U.S. Cl. 429/13; 429/40; 427/115; 502/159; 502/185

(57) ABSTRACT

An electrode paste for manufacturing a catalyst layer for an electrochemical cell, in particular a high-temperature fuel cell having a polymer fuel cell membrane, includes a catalyst material and a polymer solution. In addition to the catalyst material and the polymer solution, the electrode paste includes a solvent and at least one pore-forming material.

### BACKGROUND OF THE INVENTION

### Field of the Invention

The invention relates to an electrode paste for manufacturing a catalyst layer for an electrochemical cell, particularly for a high-temperature fuel cell having a polymer fuel cell membrane, as well as a method for manufacturing a catalyst layer.

During operation of a polymer electrolyte membrane (PEM) fuel cell, an oxidizing agent is supplied to the cathode and a reducing agent is supplied to the anode of the fuel cell. Air and a hydrogen-rich reformate or pure hydrogen are frequently used as the process gases. Anode and cathode are separated by an ion-conductive fuel cell membrane. The electrochemical oxidation of the hydrogen occurs at the anode, and the reduction of the oxygen occurs at the cathode. A high efficiency can be achieved in fuel cells through the direct conversion of chemical energy into electrical energy.

The PEM fuel cell technology which is currently furthest developed is based on fuel cell membranes made of NAFION® as the electrolyte. The electrolytic conduction occurs via hydrated protons in this case, which means that the proton conductivity of the fuel cell membrane depends on the presence of liquid water. This limits the operating temperature to below 100° C. at standard pressure.

At temperatures higher than 80° C. to 95° C., the performance deteriorates significantly because of the loss of liquid. To maintain the conductivity of the fuel cell membrane above 100° C., large quantities of water are necessary to moisten the fuel cell membrane because of the temperature dependence of the vapor pressure of water. In systems having a process gas pressure greater than standard pressure, the operating temperature may be elevated in principle, but at the cost of the efficiency, size, and weight of the overall system. For operation significantly above 100° C., the pressure required would increase drastically.

However, operating temperatures above 100° C. are desirable for varying reasons. For example, the electrokinetics and the catalytic activity for both electrodes are increased with increasing temperature. In addition, the tolerance to impurities in the combustion gas, such as carbon monoxide (CO), is higher. CO is frequently contained in hydrogen-rich reformate and must be removed at great expense before the reformate may be fed to the fuel cell. Furthermore, for use in a vehicle, the highest possible temperature in the fuel cell and therefore a large temperature differential with respect to the ambient temperature is desirable for dissipating the waste heat.

In order to achieve higher operating temperatures, using fuel cells having fuel cell membranes based on basic polymers from the group of polyazoles, whose functionality is not bound to the presence of water, has already been suggested. Significant simplifications thus result in regard to the water economy in comparison to the NAFION®-based system described above. However, until now only low power densities, typically less than 0.4 W/cm² at a voltage of 0.6 V, have been achieved in systems having such fuel cell membranes.

A fuel cell having a fuel cell membrane made of polybenzimidazole, in which an electrocatalytic layer doped with phosphoric acid is used, is known from International Publication WO 0118894 A2. An electrode paste is manufactured from a catalyst material and a polymer solution, cast on a carrier, dried, and subsequently impregnated with a mixture made of a slightly volatile acid and a non-volatile acid. The volatile acid is preferably used to improve the wetting of the surface of the dried catalyst by the non-volatile acid.

The core part of the fuel cell is its membrane electrode unit, which is formed of a fuel cell membrane having gas diffusion electrodes positioned on both sides, each of which includes a catalyst layer. The catalyst layer is either applied to a gas-permeable substrate or directly to the fuel cell membrane. The anodic oxidation of the reducing agent to protons or the cathodic reduction of the oxidizing agent occurs on the catalytic surface of the catalyst layer. The gas diffusion layer typically borders the catalyst layer, which is positioned on both sides of the fuel cell membrane. The gas diffusion layer is used both for distributing the reactants and for current discharge. Each of these individual elements and their specific interaction has great significance in the achievable power density of the fuel cell.

### SUMMARY OF THE INVENTION

It is accordingly an object of the invention to provide an electrode paste for manufacturing a catalyst layer for an electrochemical cell, in particular a high-temperature fuel cell and a method of manufacturing a catalyst layer which overcome the above-mentioned disadvantages of the heretofore-known electrode pastes and methods of manufacturing electrode pastes of this general type and which are suitable for operating temperatures up to 200° C. and at the same time provide an improved power density.

With the foregoing and other objects in view there is provided, in accordance with the invention, an electrode paste, including: a catalyst material; a polymer solution; a solvent; and a pore-forming material.

In other words, according to the invention, there is provided, an electrode paste for manufacturing a catalyst layer for an electrochemical cell, particularly a high-temperature fuel cell having a polymer fuel cell membrane, wherein the electrode paste has a catalyst material, a polymer solution, a solvent and at least one pore-forming material.

According to another feature of the invention, the solvent includes an organic solvent.

According to yet another feature of the invention, the solvent includes a dipolar-aprotic solvent.

According to a further feature of the invention, carbon is provided as a carrier for the catalyst material; and the catalyst material is a noble metal, in particular platinum.

According to yet a further feature of the invention, the pore-forming material decomposes at a given electrode-paste baking temperature and/or converts into a gaseous phase at the given baking temperature of the electrode paste.

According to another feature of the invention, the pore-forming material includes at least one component from the group of inorganic carbonates and/or an inorganic azides.

According to a further feature of the invention, the pore-forming material includes at least one member of the group of ammonium carbonate, sodium azide and/or calcium carbonate.

According to another feature of the invention, the pore-forming material includes an inorganic component with a large internal surface.

According to yet another feature of the invention, the inorganic component includes at least one component from the group of carbon, silicon dioxide and/or titanium dioxide.

According to another feature of the invention, the solvent includes at least one component from the group of N,N-dimethylformamide, N,N-dimethylacetamide and/or an acid.

According to another feature of the invention, the polymer solution includes a basic polymer from the group of polyazoles.

With the objects of the invention in view there is also provided, in combination with a fuel cell configuration having a polymer fuel cell membrane and a catalyst layer, an electrode paste for manufacturing the catalyst layer, the electrode paste including: a catalyst material; a polymer solution; a solvent; and a pore-forming material.

With the objects of the invention in view there is further provided, a method for manufacturing a catalyst layer configuration, which includes the steps of:
providing an electrode paste including a catalyst material, a solvent, a pore-forming material, and a polymer solution; and
heating the electrode paste to a given baking temperature until components of one of the solvent and the pore-forming material, that are volatile at the given baking temperature, are vaporized out of the electrode paste.

Another mode of the method of the invention includes the step of drying the electrode paste under a partial vacuum.

A further mode of the method of the invention includes manufacturing a catalyst layer with the electrode paste; and using the catalyst layer in an electrochemical cell, in particular in a fuel cell having a polymer fuel cell membrane.

Another mode of the method of the invention includes using the catalyst layer in a high-temperature fuel cell having a polymer fuel cell membrane, in particular in a high-temperature fuel cell having an operating temperature of up to 200° C.

In other words, according to the invention, there is provided, a method for manufacturing a catalyst layer for an electrochemical cell, particularly a high-temperature fuel cell having a polymer fuel cell membrane, wherein an electrode paste including at least one catalyst material, a solvent, a pore-forming material, and a polymer solution is heated at or up to a maximum baking temperature until components of the pore-forming material and/or the solvent which are volatile at the baking temperature are vaporized out of the electrode paste.

An electrode paste according to the present invention for manufacturing a catalyst layer for an electrochemical cell, particularly for a high-temperature fuel cell having a polymer fuel cell membrane, particularly for a membrane electrode unit of a fuel cell, has a catalyst material, a solvent, at least one pore-forming material, and a polymer solution. The electrode paste preferably includes an organic solvent, particularly a dipolar-aprotic solvent. The solvent is advantageously used both for dissolving the polymer, i.e., for producing the polymer solution, and for suspending the paste components. The polymer solution preferably contains the polymer from which the fuel cell membrane is formed when the fuel cell is used, which is dissolved in a typical solvent, as is disclosed in the related art cited above, for example. The catalyst material is particularly a powder made of noble metal, preferably platinum, with carbon as a carrier. However, other noble metals such as iridium or ruthenium or even other suitable materials are also conceivable. As a result of the special composition of the electrode paste and the special manufacturing of the catalyst layer produced therefrom, improved gas transport through the catalyst layer is possible, and in particular, gas channels may be implemented in the catalyst layer. The composition of the electrode paste is preferably tailored to the corresponding fuel cell membrane. For intended operating temperatures of significantly above 100° C., the pore size of the catalyst layer may be set accordingly, particularly enlarged in comparison to a pore size for a catalyst layer at or below 100° C., in order to take into consideration that at temperatures above 100° C. and low operating pressures, water no longer exists in liquid form in the large pores. It is favorable to provide more catalyst than pore-forming material.

The pore-forming material is advantageously decomposable at baking temperatures of the electrode paste; in particular, it may be converted completely into the gaseous state, and forms the desired pore structure and/or gas channel structure of the catalyst layer as it escapes from the drying electrode paste.

To allow sufficient gas permeation in the region of the active three-phase zone of the fuel cell, in which the catalyst, electrolyte, and reactants meet, compounds are advantageously considered which are porous due to their structure and are embedded in the electrode paste and therefore allow gas absorption and gas transport, as well as materials which decompose under the effect of temperature when embedded in the freshly applied electrode paste and thus cause gas channels to form.

If the pore-forming material has at least one inorganic salt, particularly a member from the group of inorganic carbonates and/or inorganic azides, preferably from the group of ammonium carbonate, sodium azide, and/or calcium carbonate, a material having good pore-forming properties which is compatible with the catalyst is available. It is thus possible to achieve a sufficiently high gas permeation in a region of an active three-phase zone of the electrochemical cell, in which an ion-conducting electrolyte, the catalyst, and reaction gases meet one another. In addition to its type, the distribution and content of the pore-former, as well as the particle size of the pore-former in the electrode paste before the decomposition are parameters of the decomposing pore-forming material by which the pore formation may be well controlled. The particle size may be achieved through different methods, such as mechanically, e.g., through milling, and/or chemically, e.g., through precipitation from a solution. Furthermore, the conditions as the temperature is elevated when drying the electrode paste, viscosity of the electrode paste, temperature gradient, and moisture content may be additional easily manageable influencing variables for implementing the desired pore structure.

Additionally or alternatively, the pore-forming material may have an inorganic component having a large internal surface, particularly at least one component from the group including carbon, in particular, appropriately modified graphite, silicon dioxide, and/or titanium dioxide. In this case as well, sufficiently extensive gas permeation into the three-phase zone is possible through the pore structure of the inorganic components.

The solvent is preferably at least one solvent from the group including N,N-dimethylformamide, N,N-dimethylacetamide, and/or an acid, particularly a strong acid such as trifluoroacetic acid.

The polymer solution is preferably tailored to a polymer of a fuel cell membrane used in the fuel cell. A basic polymer from the group of polyazoles, particularly polybenzimidazole, poly(pyridines), polybenzoxazoles, or mixtures thereof, is preferred.

In the method according to the present invention for manufacturing a catalyst layer for an electrochemical cell, particularly a fuel cell having a polymer fuel cell membrane, at least one catalyst material is admixed with a pore-forming material, a solvent, and a polymer solution, and processed at ambient temperature into an electrode paste in an essentially homogenously mixed state. The solvent is preferably organic, particularly dipolar-aprotic. The electrode paste is preferably applied to a substrate and heated under a partial vacuum at or up to a maximum baking temperature until components of the pore-forming material and solvent, which are volatile at the baking temperature, are vaporized out of the electrode paste. A preferred substrate is a gas diffusion layer made of conductive carbon. A further preferred substrate is a textile or felt material based on plastic. An especially preferred substrate, particularly for mass production, is a fuel cell membrane, particularly a fuel cell membrane based on a basic polymer from the group of polyazoles.

The present invention may be used not only for fuel cells, particularly for high-temperature fuel cells, but also for electrolysis cells, which preferably have a membrane made of a basic polymer from the group of polyazoles used as the basis for fuel cell membranes, preferably predominantly made of polybenzimidazole, poly(pyridine), polybenzoxazoles, or mixtures thereof and/or with other suitable polymers.

Other features which are considered as characteristic for the invention are set forth in the appended claims.

Although the invention is illustrated and described herein as embodied in an electrode paste for manufacturing a catalyst layer for an electrochemical cell and a method for manufacturing a catalyst layer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic sectional view of a fuel cell unit formed by multiple fuel cells according to the invention which are positioned in a stacking direction; and

FIG. 2 is a diagrammatic sectional view of an enlarged detail of a fuel cell of the fuel cell unit shown in FIG. 1.

### DESCRIPTION OF THE PREFERRED EMBODIMENTS

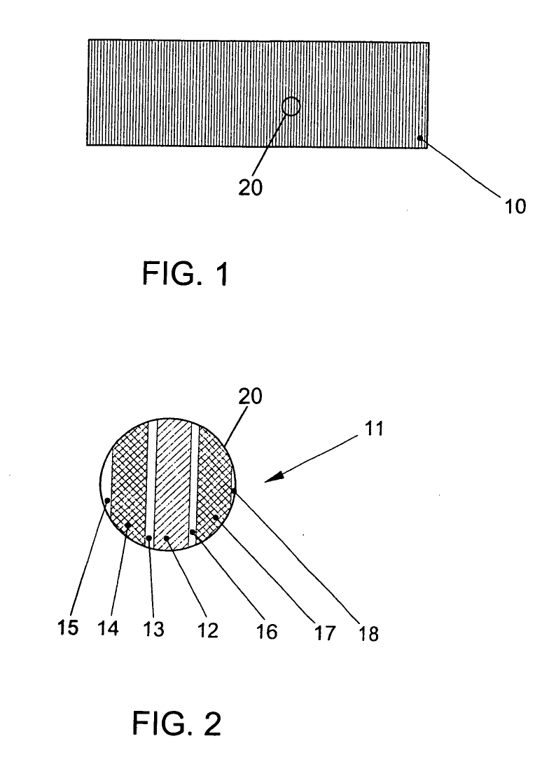

Referring now to the figures of the drawings in detail and first, particularly, to FIG. 1 thereof, there is shown an illustration of a preferred fuel cell unit 10 having multiple individual fuel cells 11, which are positioned one after another in a stacking direction. Separating devices such as bipolar plates or the like are provided between each of the individual fuel cells.

FIG. 2 illustrates a detail 20 of the fuel cell unit 10. Each fuel cell 11 has a fuel cell membrane 12, implemented as a polymer fuel cell membrane, which has a gas diffusion layer 14 and a catalyst layer 13 adjoining the fuel cell membrane 12 on its anode side, between an anode chamber 15 and the fuel cell membrane 12, and a gas diffusion layer 17 having a catalyst layer 16 adjoining the fuel cell membrane 12, symmetrically with respect to the fuel cell membrane 12 on its cathode side, between a cathode chamber 18 and the fuel cell membrane 12. The fuel cell membrane 12 and gas diffusion layers 14, 17, as well as catalyst layers 13, 16 thus form a membrane-electrode unit or membrane-electrode assembly (MEA).

When manufacturing electrodes having a catalyst layer for the preferred fuel cell 11 having a polymer fuel cell membrane based on basic polymers from the group of polyazoles, particularly for the membrane electrode unit for a fuel cell 11, at least one preferably powdered catalyst material is admixed with a solvent, a pore-forming material, and a polymer solution, and processed into an electrode paste in an essentially homogeneously mixed state.

The catalyst material preferably has a noble metal catalyst with carbon as a carrier, particularly platinum as the noble metal. Other noble metals are also conceivable besides platinum, such as iridium or ruthenium. The selection of the catalytic material depends on the type of fuel cell to be manufactured. If necessary, different catalyst materials may be provided on the anode side and the cathode side.

The electrode paste is preferably manufactured from the components without heat being supplied. A solvent, such as N,N-dimethylformamide, N,N-dimethylacetamide, or a strong acid, preferably trifluoroacetic acid, phosphoric acid, and/or their derivatives, is mixed with a pore former and a polymer solution tailored to the particular material of the fuel cell membrane 12, and in particular the same polymer is used. A favorable ratio of catalyst powder to pore former in the electrode paste is 1:0.6 (ratio in relation to the weight). A catalyst powder having a platinum loading in the electrode paste of between 10% and 70% Pt/C is preferable, more preferably 20-60%, especially preferably 50% Pt/C (percent indicated in weight-percent). A preferred pore-former which decomposes on heating is ammonium carbonate having a grain size between 0.02 mm and 0.2 mm in diameter, particularly between 0.05 mm and 0.15 mm. After mixing the components, the electrode paste is subsequently treated or cured for an extended period of time in an ultrasound bath, advantageously between 30 and 90 minutes, preferably approximately 60 minutes.

Subsequently, the electrode paste is applied to a substrate and heated and dried under partial vacuum at or up to a maximum baking temperature in a vacuum drying device until the components of the pore-forming material which are volatile at the baking temperature are vaporized from the electrode paste. The drying preferably occurs with increasing temperature, so that, for example, after 60 minutes drying time the temperature of the vacuum drying device has reached a final temperature of preferably 150° C., at which, in the case of decomposing pore-forming material, it has been converted completely into its gaseous form.

This application claims the priority, under 35 U.S.C. § 119, of German patent application No. 10 2004 024 844.3, filed May 13, 2004; the entire disclosure of the prior application is herewith incorporated by reference.

1. An electrode paste, comprising:
a catalyst material;
a polymer solution;
a solvent; and
a pore-forming material.

2. The electrode paste according to claim 1, wherein said solvent includes an organic solvent.

3. The electrode paste according to claim 1, wherein said solvent includes a dipolar-aprotic solvent.

4. The electrode paste according to claim 1, including:
carbon as a carrier for said catalyst material; and
said catalyst material being a noble metal.

5. The electrode paste according to claim 1, wherein said catalyst material is platinum.

6. The electrode paste according to claim 1, wherein said pore-forming material decomposes at a given electrode-paste baking temperature.

7. The electrode paste according to claim 1, wherein said pore-forming material converts into a gaseous phase at a given electrode-paste baking temperature.

8. The electrode paste according to claim 1, wherein said pore-forming material includes at least one component selected from the group consisting of an inorganic carbonate and an inorganic azide.

9. The electrode paste according to claim 1, wherein said pore-forming material includes at least one component selected from the group consisting of ammonium carbonate, sodium azide, and calcium carbonate.

10. The electrode paste according to claim 1, wherein said pore-forming material includes an inorganic component with a given internal surface.

11. The electrode paste according to claim 10, wherein said inorganic component includes at least one component selected from the group consisting of carbon, silicon dioxide, and titanium dioxide.

12. The electrode paste according to claim 1, wherein said solvent includes at least one component selected from the group consisting of N,N-dimethylformamide, N,N-dimethylacetamide and an acid.

13. The electrode paste according to claim 1, wherein said polymer solution includes a basic polymer and said basic polymer is a polyazole.

14. In combination with a fuel cell configuration having a polymer fuel cell membrane and a catalyst layer, an electrode paste for manufacturing the catalyst layer, comprising:
a catalyst material;
a polymer solution;
a solvent; and
a pore-forming material.

15. A method for manufacturing a catalyst layer configuration, the method which comprises:
providing an electrode paste including a catalyst material, a solvent, a pore-forming material, and a polymer solution; and
heating the electrode paste to a given baking temperature until components of one of the solvent and the pore-forming material, that are volatile at the given baking temperature, are vaporized out of the electrode paste.

16. The method according to claim 15, which comprises drying the electrode paste under a partial vacuum.

17. The method according to claim 15, which comprises:
manufacturing a catalyst layer with the electrode paste; and
using the catalyst layer in an electrochemical cell.

18. The method according to claim 15, which comprises:
manufacturing a catalyst layer with the electrode paste; and
using the catalyst layer in a fuel cell having a polymer fuel cell membrane.

19. The method according to claim 15, which comprises:
manufacturing a catalyst layer with the electrode paste; and
using the catalyst layer in a fuel cell having a polymer fuel cell membrane and the fuel cell having an operating temperature of up to 200° C.
